(19) United States
(12) Patent Application Publication
(10) Pub. No.: US 2022/0263311 A1
(43) Pub. Date: Aug. 18, 2022

(54) System and Method for Managing Power

(71) Applicant: eleXsys IP Pty Ltd, Enoggera, Queensland (AU)

(72) Inventor: Bevan HOLCOMBE, Enoggera, Queensland (AU)

(21) Appl. No.: 17/430,187

(22) PCT Filed: Feb. 12, 2020
(86) PCT No.: PCT/AU2020/050117

§ 371 Date: Mar. 16, 2022

(30) Foreign Application Priority Data
Feb. 12, 2019 (AU) 2019900446

(51) Int. Cl. H02J 1/10; H02J 1/12; H02J 1/00; H02J 3/32; H02J 3/40; H02J 7/35; H02J 9/06

(52) U.S. Cl. CPC H02J 1/102; H02J 1/12; H02J 1/002; H02J 3/32; H02J 7/0048; H02J 7/35; H02J 9/062; H02J 2300/24; H02J 3/40

(57) ABSTRACT

The present invention provides a system for managing power in an electrical power distribution network. The system includes a plurality of DC/DC converters each electrically coupled between the output of one of a plurality of DC sources and a DC bus, the converters electrically coupled to the DC bus in parallel and each converter configured to transfer power from the DC source to the DC bus; at least one DC energy storage apparatus electrically coupled to the DC bus; at least one DC/AC inverter having an input electrically coupled to the DC bus and an output electrically coupled to at least one of an AC load and an AC electrical source; and, one or more electronic processing devices that selectively controls the DC/DC converters to thereby selectively control transfer of power to the at least one energy storage apparatus.

### BACKGROUND OF THE INVENTION

The present invention relates to a system for managing power in an electrical power distribution network. In a particular form, although not limited to such, the invention relates to a system that includes solar photovoltaic (PV) power generation that is integrated with an electrical supply grid and includes energy storage.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

The boom in the uptake of solar PV power generation by residential, commercial and industrial electricity customers has largely been driven by financial incentives including feed-in-tariffs and other subsidies. As these incentives have gradually been reduced in previous years, the mantra has moved towards ‘self-consumption’ of power produced. As solar PV systems typically produce maximum power during the day when loads are typically low, the excess energy is exported to the electrical supply grid and not consumed by the customer to power loads. At night time, when the solar system is inactive and loads are typically highest, the loads will draw power from the grid and the customer will have to pay for electricity generated by the grid operator.

It is therefore desirable to include energy storage in the system so that excess power generated by the solar PV system can be stored by the energy storage for use when the solar PV system is inactive. The integration of energy storage, particularly significant energy storage, into a grid-connected solar PV system is not however a trivial task as performance, efficiency and cost attributes must be taken into consideration.

For example, systems incorporating energy storage have typically suffered from inefficiencies resulting from numerous energy conversion stages between the solar modules and storage prior to supply to loads or the grid. Furthermore, energy storage systems have previously used low voltage batteries as the storage medium which typically require a low frequency transformer which decreases efficiency.

It would therefore be advantageous to provide a system that is capable of managing power in an electrical power distribution network that integrates energy storage into a grid-connected solar PV system in an efficient manner.

### SUMMARY OF THE PRESENT INVENTION

In one broad form an aspect of the present invention seeks to provide a system for managing power in an electrical power distribution network, the system including: a plurality of DC/DC converters each electrically coupled between the output of one of a plurality of DC sources and a DC bus, the converters electrically coupled to the DC bus in parallel and each converter configured to transfer power from the DC source to the DC bus; at least one DC energy storage apparatus electrically coupled to the DC bus; at least one DC/AC inverter having an input electrically coupled to the DC bus and an output electrically coupled to at least one of an AC load and an AC electrical source; and, one or more electronic processing devices that selectively controls the DC/DC converters to thereby selectively control transfer of power to the at least one energy storage apparatus.

In one embodiment the one or more electronic processing devices independently control an output of each DC/DC converter in accordance with at least one of a converter output voltage and a DC bus voltage.

In one embodiment the output voltage of each DC/DC converter is greater than a respective input voltage of each converter.

In one embodiment control of the output of each DC/DC converter is dependent on at least one of: a charge limit of the at least one energy storage apparatus; a discharge limit of the at least one energy storage apparatus; a State of Charge (SOC) of the at least one energy storage apparatus; and a State of Health (SOH) of the at least one energy storage apparatus.

In one embodiment the one or more electronic processing devices transmit a common voltage limit to each DC/DC converter.

In one embodiment the common voltage limit is indicative of the maximum charge voltage of the at least one energy storage apparatus.

In one embodiment the one or more electronic processing devices cause each DC/DC converter to: implement a Maximum Power Point Tracking (MPPT) algorithm until the output of the DC/DC converter reaches the common voltage limit; and regulate the output once the voltage limit is reached so that the voltage limit is not exceeded.

In one embodiment the common voltage limit is at least 600 VDC.

In one embodiment one or more of the DC/DC converters are galvanically isolated.

In one embodiment the at least one energy storage apparatus includes one or more batteries having a nominal operating voltage of at least 600 VDC.

In one embodiment the DC sources include solar photovoltaic (PV) power modules.

In one embodiment the DC/DC converters are integrated with the PV power modules.

In one embodiment the inverter is a bidirectional DC/AC inverter having an output coupled to the AC source via an impedance.

In one embodiment the inverter includes a distribution static compensator (dSTATCOM).

In one embodiment the inverter is controllable by the one or more electronic processing devices to selectively cause power to flow between the DC bus and at least one of the AC load and an AC electrical source.

In one embodiment control of the inverter takes precedence over control of the DC/DC converters.

In one embodiment the system includes wireless communication between at least the one or more electronic processing devices, DC/DC converters, at least one energy storage apparatus and the inverter.

In one broad form an aspect of the present invention seeks to provide a method for managing power in an electrical power distribution network, the method including in one or more electronic processing devices: determining one or more parameters of a system, the system including: a plurality of DC/DC converters each electrically coupled between the output of a respective DC source and a DC bus, the converters electrically coupled to the DC bus in parallel and each converter configured to transfer power from the DC source to the DC bus; at least one DC energy storage apparatus electrically coupled to the DC bus; and, at least one DC/AC inverter having an input electrically coupled to the DC bus and an output electrically coupled to at least one of an AC load and an AC electrical source; and, selectively controlling the DC/DC converters in accordance with the determined parameters to thereby selectively control transfer of power to the at least one energy storage apparatus.

In one embodiment an output of each DC/DC converter is independently controlled in accordance with the determined parameters including at least one of a converter output voltage and a DC bus voltage.

In one embodiment the method includes, in the one or more electronic processing devices, transmitting a common voltage limit to each DC/DC converter.

In one embodiment the method includes, in the one or more electronic processing devices: implementing a Maximum Power Point Tracking (MPPT) algorithm in each DC/DC converter until the output of the DC/DC converter reaches the common voltage limit; and regulating the output once the voltage limit is reached so that the voltage limit is not exceeded.

In one embodiment the method includes, in the one or more electronic processing devices, controlling the inverter to selectively cause power to flow between the DC bus and at least one of the AC load and an AC electrical source.

In one embodiment control of the inverter takes precedence over control of the DC/DC converters.

In one embodiment the method includes, in one or more electronic processing devices: determining parameter values of one or more operating parameters of the AC source; determining target parameter values of the one or more operating parameters; determining a difference between the parameter values and target parameter values; and, generating a control signal based at least in part on the determined difference to control the inverter and thereby selectively cause power flow between the DC bus and the AC source, the power flow causing the parameter values to tend towards the target parameter values.

In one embodiment the one or more operating parameters of the AC source include at least one of: AC source frequency; AC source voltage; Phase loading; and Load power factor.

In one embodiment the AC source includes at least one of a utility grid or a generator.

In one embodiment the step of determining the parameter values includes, in the at least one electronic processing device: determining measured values of an AC voltage magnitude, AC current magnitude and AC current phase angle at the inverter output; and determining measured values of an AC voltage magnitude, AC current magnitude and AC current phase angle at the AC source.

In one embodiment the control signal causes the inverter to at least one of: cause power flow from the AC source to the DC bus; and, cause power flow from the DC bus to the AC source.

In one embodiment the control signal causes the inverter to cause power flow from the DC bus to the at least one AC load.

In one embodiment the power flow includes at least one of real power (kW) and reactive power (kVAR).

In one embodiment the method includes, in the at least one electronic processing device, generating a control signal which causes the inverter to actuate one or more switching devices to control operation of the at least one AC load.

In one embodiment the at least one electronic processing device causes the inverter output to become synchronised with the AC source.

In one embodiment at least the one or more electronic processing devices, the inverter, the energy storage apparatus, the at least one AC load, the AC source and one or more external communication networks are controlled through wireless communication.

In one embodiment the control signal is generated at least in part by a machine learning algorithm or from historical data of the one or more operating parameters of the AC source.

In one embodiment the method includes, in one or more electronic processing devices, generating a plurality of control signals based at least in part on the determined difference to control a plurality of inverters and thereby selectively cause power flow between a plurality of energy storage apparatus and the AC source, the power flow causing the parameter values to tend towards the target parameter values.

### BRIEF DESCRIPTION OF THE DRAWINGS

An example of the present invention will now be described with reference to the accompanying drawings, in which: —

FIG. 1 is a schematic diagram of an example of a system for managing power in an electrical power distribution network;

FIG. 2 is a schematic diagram of an example of a communication system;

FIG. 3 is a flowchart of an example of a method of managing power in an electrical power distribution network;

FIG. 4 is a is a flowchart of an example of a method of managing power in an electrical power distribution network using battery maximum charge voltage as a system parameter;

FIG. 5 is a flowchart of a second example of a method for managing power in an electrical power distribution network;

FIG. 6 is a flowchart of an example of a method for managing power in an electrical power distribution network using the voltage level of the AC source as an operating parameter; and

FIG. 7 is a schematic diagram of another example of a system for managing power in an electrical power distribution network.

### DETAILED DESCRIPTION OF THE PREFERRED EMBODIMENTS

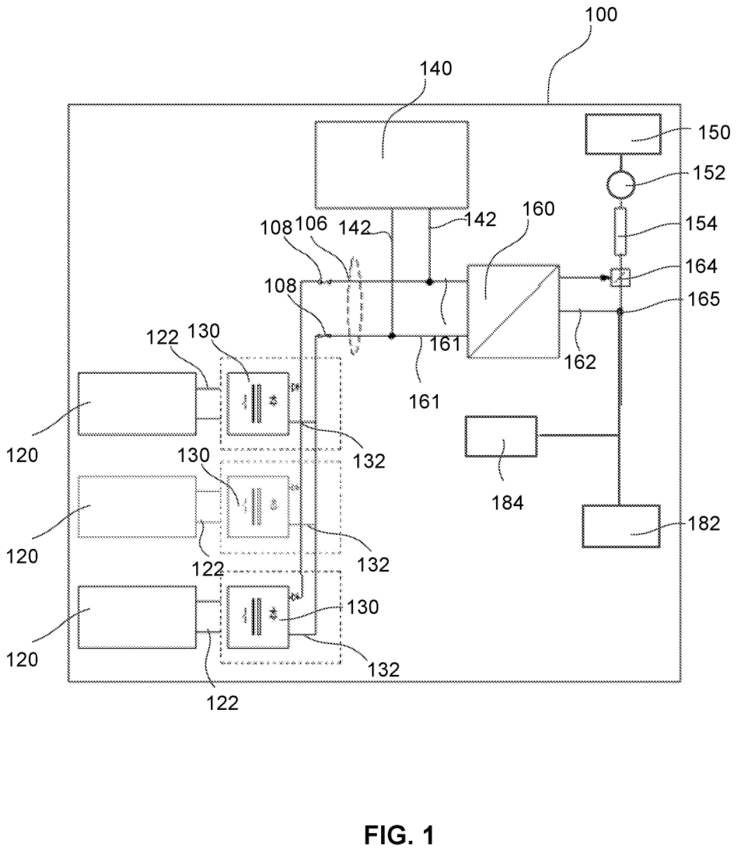

An example of a system for managing power in an electrical power distribution network will now be described with reference to FIG. 1. It will be appreciated from the following that the system could be used with any power source capable of producing a DC output including, but not limited to, fuel cells, DC generators, wind turbines and solar PV cells. In the example shown, the DC sources comprise a plurality of solar PV modules which for instance may form part of a roof-mounted solar PV array, but this is not intended to be limiting.

In this example, the system 100 includes a plurality of DC/DC converters 130 each electrically coupled between the output 122 of a respective DC source 120 and a DC bus 106, the converters 130 being electrically coupled to the DC bus 106 in parallel and each converter 130 being configured to transfer power from the DC source 120 to the DC bus 106.

The system 100 also includes at least one energy storage apparatus 140 electrically coupled to the DC bus 106 and at least one DC/AC inverter 160 having an input 161 electrically coupled to the DC bus 106 and an output 162 electrically coupled to at least one of an AC load 182, 184 and an AC electrical source 150. The energy storage apparatus 140 may be any suitable storage device including an electrochemical storage device such as a battery or electrostatic energy storage device such as a capacitor or hydrogen storage for example. In the example shown, the energy storage apparatus 140 comprises one or more batteries. The AC electrical source 150 will typically be the electric grid or utility supply network but could also be a stand alone AC generator. AC loads 182, 184 represent both controlled and uncontrolled loads in the system including for example customer loads such as AC appliances and industrial loads such as induction motors and various other AC machines.

Although not illustrated in FIG. 1, the system 100 further includes one or more electronic processing devices that selectively control the DC/DC converters 130 to thereby selectively control transfer of power to the at least one energy storage apparatus 140, as will be described in more detail below.

An advantage of the above described system is that it enables the grid integration of solar power generation with DC energy storage in an efficient manner. As the solar PV modules 120 and DC/DC converters 130 are connected in parallel the energy output of the solar modules can be maximised. For solar modules connected in series, the maximum output of the system is constrained by the weakest PV cell. As such, the total output is vulnerable to variable shading, panel orientation, poor quality of PV cells and/or connections etc.

Additionally, the above described system has only a single power inversion stage which occurs after the PV output has been stored by the energy storage apparatus 140. This minimises the number of energy conversions required between the solar output and the energy storage apparatus prior to supply to the AC source and/or AC loads.

The ability to selectively control the DC/DC converters 130 to thereby selectively control transfer of power to the at least one energy storage apparatus 140 further ensures that the DC bus voltage is regulated enabling the energy storage apparatus 140 to be charged in an efficient manner as will be described in further detail below.

A number of further features will now be described.

Typically, the one or more electronic processing devices independently control an output of each DC/DC converter in accordance with at least one of a converter output voltage and a DC bus voltage. These parameters may be measured using any suitable voltage sensor including for example a voltmeter, multimeter, vacuum tube voltmeter (VTVM), field effect transistor voltmeter (FET-VM), or the like. Independently controlling the DC/DC converters is advantageous as it enables the system to be inherently scalable (that is the system may comprise any number of solar PV modules, energy storage apparatus or inverters).

The control of the output of each DC/DC converter is dependent on at least one of a charge limit of the at least one energy storage apparatus, a discharge limit of the at least one energy storage apparatus, a State of Charge (SOC) of the at least one energy storage apparatus and a State of Health (SOH) of the at least one energy storage apparatus.

The State of Health (SOH) of the energy storage apparatus represents the condition of the storage apparatus compared to ideal conditions and may include consideration of factors including internal resistance, capacity, voltage, self-discharge, number of charge/discharge cycles etc. Taking one or more of the above parameters of the energy storage apparatus into account enables the DC/DC converters to be controlled so that the energy storage apparatus may be charged efficiently without causing any damage through charging at a voltage exceeding the charge voltage limit for example.

In a specific example, the one or more electronic processing devices transmit a common voltage limit to each DC/DC converter. In an example, the common voltage limit is indicative of the maximum charge voltage of the at least one energy storage apparatus. Having set the common voltage limit for each DC/DC converter, the one or more electronic processing devices cause each DC/DC converter to implement a tracking algorithm (for example a Maximum Power Point Tracking (MPPT) algorithm) until the output of a DC/DC converter reaches the common voltage limit and regulate the output once the voltage limit is reached so that the voltage limit is not exceeded.

Typically the common voltage limit is at least 600V. Storing energy at a high voltage such as this is an efficient means of storing electrical energy compared to low voltage storage (48 VDC lead acid batteries for example) which typically require a low frequency transformer which is inefficient.

The inverter, which is preferably bi-directional with an output coupled to the AC source via an impedance, is controllable by the one or more electronic processing devices to selectively cause power to flow between the DC bus and at least one of the AC load and the AC source. Accordingly, the one or more processing devices control both power flow from the DC/DC converters to the energy storage apparatus to optimise battery charging and power flow through the inverter between the DC bus and at least one of the AC load and AC source to provide power to loads or the grid for example to control one or more operating parameters of the AC source. In a preferred control hierarchy, control of the inverter takes precedence over control of the DC/DC converters. In other words, control of the AC side of the system has priority over control of the battery charging in a two-tiered control hierarchy.

Typically, the system includes wireless communication between at least the one or more electronic processing devices, DC/DC converters, at least one energy storage apparatus and the inverter. The system may also communicate wirelessly with the one or more AC loads, an external communication network (for example to communicate with the grid) and an AC source meter configured to measure and record how much electricity a household or business is consuming from the AC source at a regular time interval.

In one example, a control method for managing power includes, in one or more electronic processing devices, determining parameter values of one or more operating parameters of the AC source including at least one of AC source frequency, AC source voltage, phase loading and load power factor. The method further includes determining target parameter values of the one or more operating parameters and determining a difference between the parameter values and target parameter values. The method then includes generating a control signal based at least in part on the determined difference to control the inverter and thereby selectively cause power flow between the DC bus and the AC source, the power flow causing the parameter values to tend towards the target parameter values.

In this way, the inverter can be used to control AC side parameters of a power distribution network including operating parameters of the AC source. In some examples, power flow may be directly between the AC source and the energy storage apparatus via the DC bus.

The step of determining the parameter values includes, in the at least one electronic processing device determining measured values of an AC voltage magnitude, AC current magnitude and AC current phase angle at the inverter output and determining measured values of an AC voltage magnitude, AC current magnitude and AC current phase angle at the AC source. From these measurements, all other AC side parameters such as load power factor etc. may be determined.

In one example, the control signal generated by the one or more electronic processing devices, causes the inverter to at least one of cause power flow from the AC source to the DC bus and cause power flow from the DC bus to the AC source.

In another example, the control signal generated by the one or more electronic processing devices, causes the inverter to at least one of cause power flow from the AC source to the energy storage apparatus and cause power flow from the energy storage apparatus to the AC source.

In a further example, the control signal causes the inverter to cause power flow from the DC bus to the one or more loads. In the above examples, the power flow includes at least one of real power (kW) and reactive power (kVAR).

In a further example, the method includes, in the at least one electronic processing device, generating a control signal which causes the inverter to actuate one or more switching devices to control operation of the one or more loads. For example, the switching devices (e.g. relays or switches) may regulate the power drawn by the load or completely disconnect the load from the network.

While the control signal may be generated based on determined parameter values obtained through measurement or the like, it is also possible that the control signal may be generated at least in part by a machine learning algorithm or from historical data of the one or more parameters of the network such as typical peak load values expected at a certain time of day for example.

In a further example, the method includes, in the one or more electronic processing devices, generating a plurality of control signals based at least in part on the determined difference to control a plurality of inverters and thereby selectively cause power flow between a plurality of energy storage apparatus and the AC source, the power flow causing the parameter values to tend towards the target parameter values. In a system having a plurality of inverter and energy storage apparatus modules, great control capability is provided as the modules may be installed at selected locations along a distribution feeder line for example where they are most needed to support the network.

The system architecture shown in FIG. 1 will now be described in further detail. The system 100 includes a plurality of solar PV modules 120 which may form part of a roof-mounted PV array of a residential building for example. The low voltage output 122 of each PV module (typically less than 80 VDC) is electrically coupled to a DC/DC converter 130. In one example, each DC/DC converter is integrated with the PV module which may be achieved for example by using high frequency magnetic components in the converters. The DC/DC converters 130 may also be galvanically isolated and/or provide fault detection as described for example in copending patent application number WO2014/078904.

Galvanically isolating the DC/DC converters enables other components of the system such as the inverter to be non-isolated.

The DC/DC converters 130 are electrically coupled in parallel to a DC bus 106 via protective fuses 108. The DC bus 106 is preferably a high voltage DC bus (typically at least 600 VDC). Accordingly, the output voltage of each DC/DC converter is greater than a respective input voltage of each converter. Specifically, the DC/DC converters 130 function to step up the low voltage output from the solar modules to the high voltage of the DC bus 106. The high voltage DC bus 106 is advantageous as it inherently reduces the size/cost of the conductors and capacitors required.

An energy storage apparatus 140 is electrically coupled to the DC bus 106. Typically, the energy storage apparatus 140 comprises one or more high voltage batteries that are directly connected to the DC bus 106. The DC bus 106 is also electrically coupled to a DC/AC inverter 160 which delivers power from the solar modules 120 and/or battery 140 to an AC source 150 and one or more AC loads 182, 184 which form part of an electrical power distribution network. The grid-tied DC/AC inverter 160 therefore converts the DC bus voltage into an AC mains or grid voltage at mains frequency (e.g. 230-240 VAC, 50 Hz).

In one example, the inverter 160 is a four quadrant self synchronising type that runs synchronised to the AC source 150 through a small impedance 154 via a synchronising contactor 164. An example of an inverter topology that may be used in the system is described in Wolfs, P and Maung Than Oo (2013), “A LV Distribution Level STATCOM with Reduced DC Bus Capacitance for Networks with High PV Penetrations”, IEEE Power and Energy Society General Meeting (PES). Accordingly, the inverter 160 may be a bidirectional DC/AC inverter that includes a distribution static compensator (dSTATCOM) such that the inverter can facilitate power transfer to and from the AC source 150. For example, power may be transferred from the DC bus 106 to the AC source 150 or from the AC source 150 back onto the DC bus 106 and into battery 140.

The system 100 may further include metering at the AC source 150. Preferably, the meter 152 is a smart meter capable of measuring and recording how much electricity a household or business is consuming from the AC source 150 at a regular time interval.

As previously stated, the system 100 also includes one or more electronic processing devices that selectively control the DC/DC converters 130 to thereby selectively control transfer of power to the at least one energy storage apparatus 140. The one or more electronic processing devices further control operation of the inverter 160 and in some examples the battery 140 and local loads 182 184.

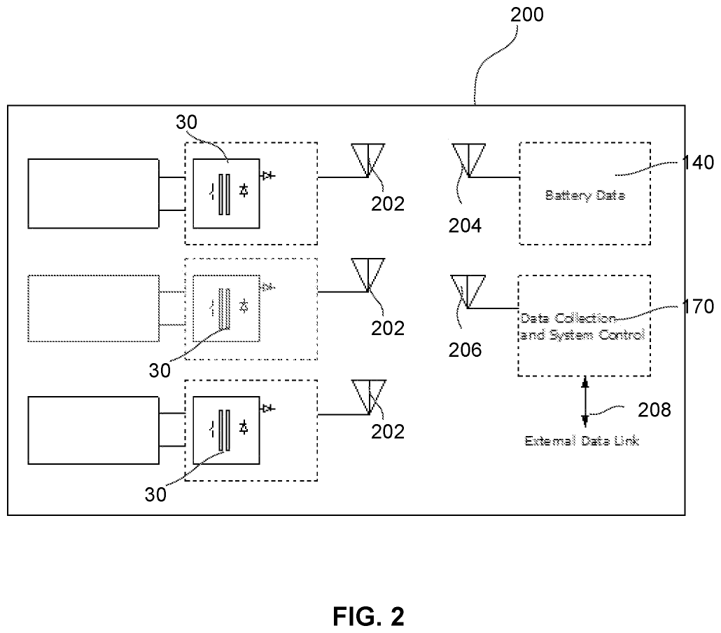

Now referring to FIG. 2 it is shown that various devices of the system 100 may communicate via a communication network 200. The devices can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, Zigbee or the like.

In the example shown, the DC/DC converters 30 are connected to the network at nodes 202, the battery 140 communicates data via node 204 and a system controller 170 (consisting of the one or more electronic processing devices) is connected via node 206. The system controller 170 may be connected to an external communication network 208 which may communicate for example with a utility grid operator. Although not shown, it is to be appreciated that the inverter, AC loads and AC source meter will also be connected to the communication network 200 via respective nodes.

Whilst the system controller 170 may be a single entity, it will be appreciated that the system controller 170 can be distributed over a number of geographically separate locations, for example by using processing systems and/or databases that are provided as part of a cloud based environment. However, the above described arrangement is not essential and other suitable configurations could be used.

In one example, system controller 170 may include any suitable electronic processing device(s), including one or more processing systems, which optionally may be coupled to one or more databases for example containing information about historical loads and AC source parameters. Accordingly, the one or more processing systems can include any suitable form of electronic processing system or device that is capable of controlling one or more of the inverter, DC-DC converters, energy storage apparatus, local loads, AC source meter and external communication networks.

In one example, a suitable processing system includes a processor, a memory, an input/output (I/O) device, such as a keyboard and display, and an external interface coupled together via a processing system bus. It will be appreciated that the I/O device may further include an input, such as a keyboard, keypad, touch screen, button, switch, or the like thereby allowing a user to input data, however this is not essential. The external interface is used for coupling the processing system to the system devices including the inverter, DC-DC converters, energy storage apparatus, local loads, AC source meter and external communication networks.

In use, the processor executes instructions in the form of applications software stored in the memory to at least allow selective control of the DC/DC converters 130 to thereby selectively control transfer of power to the at least one energy storage apparatus 140. Accordingly, for the purposes of the following description, it will be appreciated that actions performed by the one or more processing systems are typically performed by the processor under control of instructions stored in the memory, and this will not therefore be described in further detail below.

Accordingly, it will be appreciated that the one or more processing devices may be formed from any suitably programmed processing system. Typically however, an electronic processing device would be in the form of a microprocessor, microchip processor, logic gate configuration, firmware optionally associated with implementing logic such as an FPGA (Field Programmable Gate Array), an EPROM (Erasable Programmable Read Only Memory), or any other electronic device, system or arrangement capable of interacting and controlling the various devices in the system.

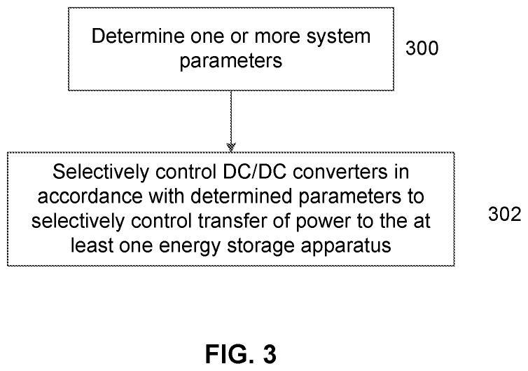

Now referring to FIG. 3, there is shown a flowchart of an example of a method of managing power from a plurality of DC sources. At step 300, the one or more electronic processing devices determine one or more system parameters including for example, the output voltage of a respective DC/DC converter, the DC bus voltage, charge limit of the energy storage apparatus, discharge limit of the energy storage apparatus, State of Charge (SOC) of the energy storage apparatus and State of Health (SOH) of the energy storage apparatus. The state of health of the energy storage apparatus represents the condition of the storage apparatus compared to ideal conditions and may include consideration of factors including internal resistance, capacity, voltage, self-discharge, number of charge/discharge cycles etc. At step 302, the one or more determined parameters are then interpreted by the one or more electronic processing devices and used to selectively control the DC/DC converters to selectively control transfer of power to the at least one energy storage apparatus from the plurality of DC sources.

This control method enables the system to regulate the output of the DC sources (e.g. solar PV modules) in order to optimise charging of the energy storage apparatus. Preferably, each DC/DC converter is controlled autonomously, independent of the system configuration such that the architecture is fully scalable.

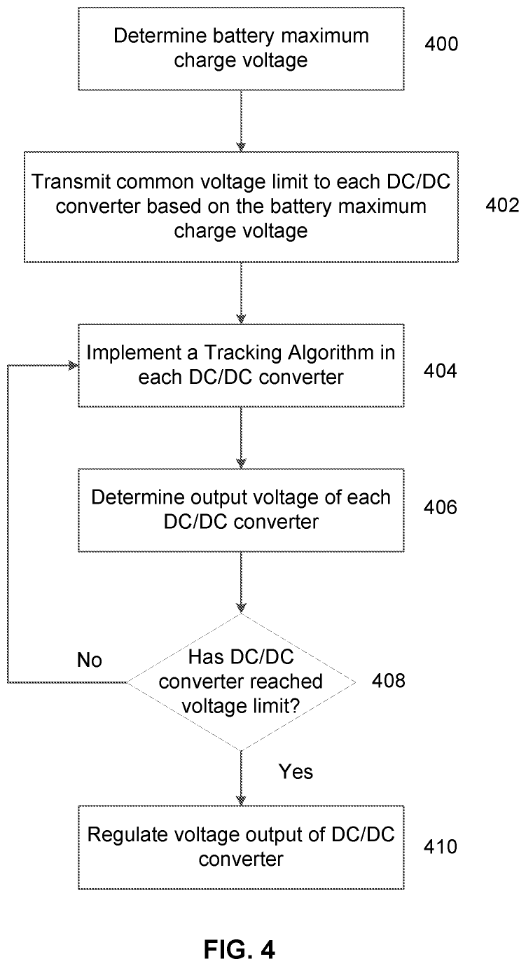

A specific example of a suitable control method is shown in FIG. 4. In this example, at step 400 the system parameter determined by the one or more processing devices is the battery maximum charge voltage. This parameter may be communicated to the one or more processing devices wirelessly from the battery. At step 402, this voltage is transmitted or broadcast by the one or more processing devices to each DC/DC converter. The voltage is then used as a common voltage limit by each DC/DC converter.

Assuming that the solar PV modules are active, at step 404, the one or more processing devices cause each DC/DC converter to implement a tracking algorithm such as a Maximum Power Point Tracking (MPPT) algorithm which enables the maximum power to be obtained from each PV module of the system. Each DC/DC converter will operate in MPPT mode up until the voltage output of an individual DC/DC converter reaches the common voltage limit. At step 406, the one or more electronic processing devices determine the voltage output of each DC/DC converter and at step 408 each voltage output is compared against the common voltage limit. If it is determined that the voltage output of a particular converter has reached the common voltage limit set then at step 410 the one or more processing devices cause the voltage output of the particular converter to be regulated such that the output voltage falls back below the limit.

Each DC/DC converter is independently controlled such that the output of one or more converters may be regulated while the other converters still operate in MPPT mode for example. In this way, each DC/DC converter is controlled independently of what the others are doing so that the system is inherently scalable (that is the system may comprise any number of solar modules, energy storage apparatus or inverters).

In addition to selectively controlling the DC/DC converters to selectively control transfer of power to the at least one energy storage apparatus, the one or more processing devices may further be used to control the inverter to selectively cause power flow between the DC bus and the AC source to thereby control operating parameters of the AC source.

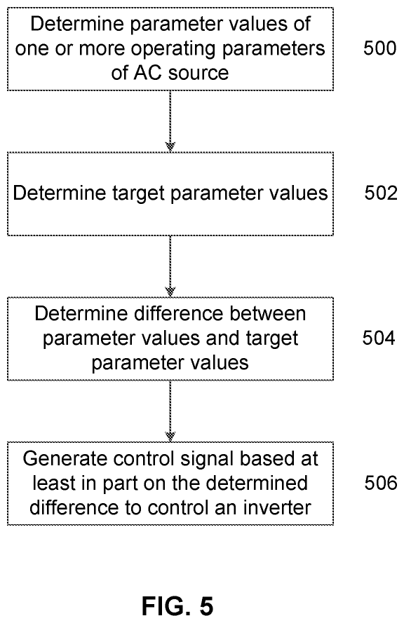

Referring now to FIG. 5, there is shown a second example of a method for managing power in an electrical power distribution network which seeks to control one or more operating parameters of the AC source. At step 500, the one or more electronic processing devices determine parameter values of one or more operating parameters of the AC source. For example, in the case where the AC source is the mains power grid of a power distribution network, the one or more operating parameters may include the AC source voltage, AC source frequency, phase loading (for a three phase system) and load power factor. The load power factor is the ratio of real power (kW) to apparent power (kVA) (which is the combination of real power and reactive power (kVAR)). A load that consumes or generates reactive power will draw more current from the AC source for a given amount of real power transferred that actually does work to power the load. A load with a low power factor therefore draws more current from the AC source and is inefficient.

The one or more parameter values of the one or more operating parameters may be determined from suitable measurements. In one example, measurements of AC voltage magnitude, AC current magnitude and AC current phase angle are made at the AC source meter and measurements of AC voltage magnitude, AC current magnitude and AC current phase angle are made at the AC output of the inverter. From these measurements, the one or more processing devices can determine all operating parameters of the AC source. Measurements of AC voltage may be made using any suitable voltage sensor including for example a voltmeter, multimeter, vacuum tube voltmeter (VTVM), field effect transistor voltmeter (FET-VM), or the like. Measurements of AC current may be made using any suitable current sensor including a multimeter, ammeter, picoammeter, or the like.

At step 502, target parameter values of the one or more operating parameters are determined by the one or more processing devices. For example, the one or more processing devices may receive data from the utility grid indicative of the target parameter values or the target values may be retrieved from a database. At step 504, the one or more processing devices determine the difference between the actual parameter values of the one or more operating parameters and the target parameter values. At step 506, the one or more processing devices generate a control signal based at least in part on the determined difference to control the inverter to transfer power between the energy storage apparatus and the AC source. The resulting power flow to or from the inverter causes the parameter values to tend towards the target parameter values. In this way, the energy storage apparatus may be used as a power source or sink to increase the efficiency and power quality of the power distribution network.

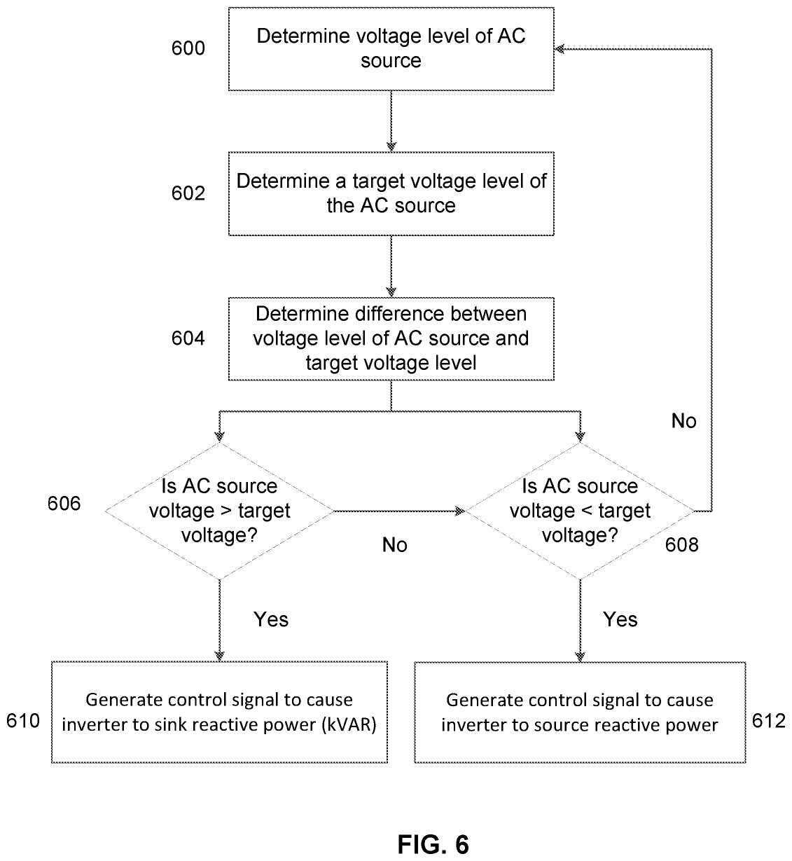

A specific example is shown in FIG. 6 of a method of managing power in an electrical power distribution network. In this example, at step 600, the one or more processing devices determine the AC voltage level of the AC source. For example, the AC voltage may be suitably measured by a voltage sensor located at the AC source meter which sends a signal indicative of the AC source voltage to the one or more processing devices. At step 602, the target voltage level of the AC source is determined (the target voltage level may be an acceptable range having an upper and lower limit). For the case of the AC source being a mains utility grid, the utility operator will set the target voltage level. At step 604, the difference between the voltage level of the AC source and the target voltage level is determined by the one or more processing devices.

At steps 606 and 608, the one or more processing devices determine whether the AC source voltage is greater than or less than the target voltage respectively. In other words, the system determines whether there is an overvoltage problem or an undervoltage problem in the network. In response to overvoltage, at step 610 the one or more processing devices generate a control signal to cause the inverter to sink reactive power from the AC source to the energy storage apparatus to thereby lower the AC source voltage. In response to undervoltage, at step 612 the one or more processing devices generate a control signal to cause the inverter to source reactive power from the energy storage apparatus to the AC source to thereby increase the AC source voltage.

In another example, for a system having a low load power factor (for instance when there are one or more inductive AC loads consuming reactive power) the inverter can be used to inject reactive power onto the grid or to supply reactive power directly to the load in order to increase the load power factor to an acceptable level.

In another example, since the inverter is synchronised with the AC source, the system is capable of providing an uninterrupted power supply (UPS) function for the one or more AC loads when for example, the AC source is lost or incapable of supplying sufficient power for the loads. In this example, assuming that the energy storage has sufficient capacity, the system can source power from the energy storage apparatus to power the one or more AC loads.

In another example, the system may be used to reduce voltage unbalances in three phase networks by dynamic load balancing. The voltage level of each phase may be measured using a suitable voltage sensor. The one or more electronic processing devices then determine the voltage levels based on these measurements and send a control signal to the inverter to cause power to be transferred from an overloaded phase to a lightly loaded phase. Alternatively, the inverter may cause power flow (e.g. reactive power compensation) from the energy storage apparatus to the one or more lightly loaded phases to balance the overloaded phase.

In the above examples, the operating parameters of the AC source may be controlled preferentially over the charging of the energy storage apparatus in a two-tiered form of control hierarchy. For example, control of the inverter is given precedence over control of the DC/DC converters charging the energy storage apparatus. As such the inverter will sink/source power between the DC bus and the AC source as appropriate in order to maintain satisfactory operating parameters of the AC source. In this way, the inverter controls what the DC bus voltage will be depending on whether power is being sourced or sinked through the inverter. The DC/DC converters will therefore be subservient to control of the AC source parameters so for example if the inverter is drawing power from the DC bus, the DC/DC converters will simply continue operating in an MPPT mode to maximise power output of the solar PV modules and maintain the DC bus voltage. If the inverter is not drawing power from the DC bus, the DC/DC converters will charge the battery and operate in MPPT mode until they reach a maximum voltage limit (as previously described for example) and then regulate their output so that the battery maximum charge voltage is not exceeded.

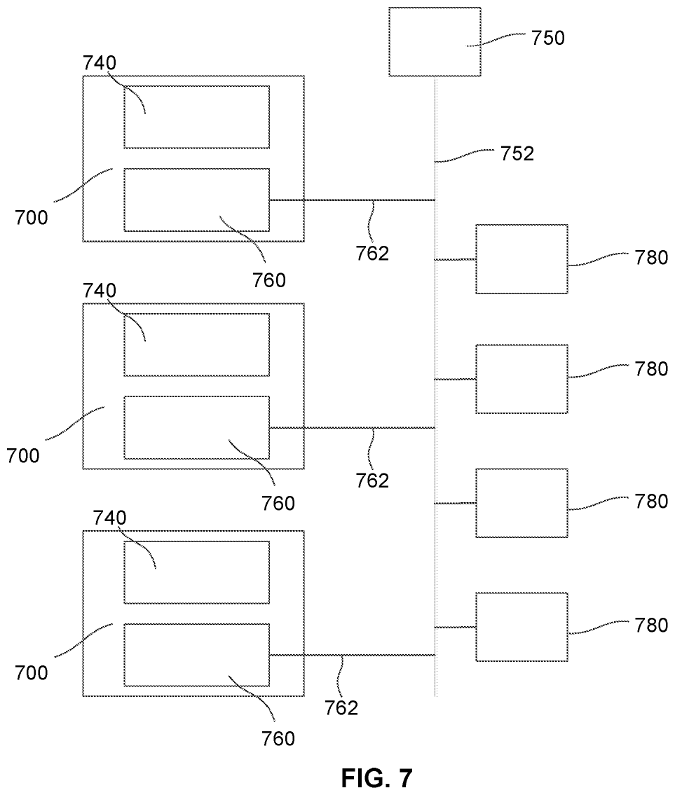

Referring now to FIG. 7, there is shown another example of a system for managing power in an electrical power distribution network. The system comprises a plurality of energy storage apparatus 740 (for example high voltage batteries) that are each electrically coupled to a respective DC/AC inverter via a respective high voltage DC bus. The output 762 of each DC/AC inverter 760 is electrically coupled to an AC source 750. For example, each inverter 760 may be coupled to a feeder line of an electric grid where the AC source represents a distribution feeder. A plurality of loads 780 are coupled to the grid. In one example, each module 700 comprising at least of an energy storage apparatus 740 and DC/AC inverter 760 may be installed by the utility operator at selective locations along the feeder line where they can be best utilised to support the power distribution network. In another example, each module 700 may represent a residentially installed system.

In the arrangement shown in FIG. 7, each module 700 may be used to support the network and improve operating parameters such as AC source voltage, AC source frequency, phase loading (for a three phase system) and load power factor. Additionally, the modules 700 may communicate with each other so that for example if the load in one part of the network is low (and a battery has sufficient charge), the battery may be used to supply power to another battery that has a low level of charge or a part of the network where the load is high.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1) A system for managing power in an electrical power distribution network, the system including:
a) a plurality of DC/DC converters each electrically coupled between the output of one of a plurality of DC sources and a DC bus, the converters electrically coupled to the DC bus in parallel and each converter configured to transfer power from the DC source to the DC bus;
b) at least one DC energy storage apparatus electrically coupled to the DC bus;
c) at least one DC/AC inverter having an input electrically coupled to the DC bus and an output electrically coupled to at least one of an AC load and an AC electrical source; and,
d) one or more electronic processing devices that selectively controls the DC/DC converters to thereby selectively control transfer of power to the at least one energy storage apparatus.

2) A system according to claim 1, wherein the one or more electronic processing devices independently control an output of each DC/DC converter in accordance with at least one of a converter output voltage and a DC bus voltage.

3) A system according to claim 1, wherein the output voltage of each DC/DC converter is greater than a respective input voltage of each converter.

4) A system according to claim 3, wherein control of the output of each DC/DC converter is dependent on at least one of:
a) a charge limit of the at least one energy storage apparatus;
b) a discharge limit of the at least one energy storage apparatus;
c) a State of Charge (SOC) of the at least one energy storage apparatus; and
d) a State of Health (SOH) of the at least one energy storage apparatus.

5) A system according to claim 4, wherein the one or more electronic processing devices transmit a common voltage limit to each DC/DC converter.

6) A system according to claim 5, wherein the common voltage limit is indicative of the maximum charge voltage of the at least one energy storage apparatus.

7) A system according to claim 6, wherein the one or more electronic processing devices cause each DC/DC converter to:
a) implement a Maximum Power Point Tracking (MPPT) algorithm until the output of the DC/DC converter reaches the common voltage limit; and
b) regulate the output once the voltage limit is reached so that the voltage limit is not exceeded.

8) A system according to claim 5, wherein the common voltage limit is at least 600 VDC.

9) A system according to claim 1, wherein at least one of:
a) one or more of the DC/DC converters are galvanically isolated;
b) the at least one energy storage apparatus includes one or more batteries having a nominal operating voltage of at least 600 VDC;
c) the DC sources include solar photovoltaic (PV) power modules; wherein, optionally, the DC/DC converters are integrated with the PV power modules;
d) the inverter is a bidirectional DC/AC inverter having an output coupled to the AC source via an impedance; and,
e) the system including wireless communication between at least the one or more electronic processing devices, DC/DC converters, at least one energy storage apparatus and the inverter.

10) (canceled)

11) (canceled)

12) (canceled)

13) (canceled)

14) A system according to claim 9, wherein the inverter at least one of:
a) includes a distribution static compensator (dSTATCOM); and
b) is controllable by the one or more electronic processing devices to selectively cause power to flow between the DC bus and at least one of the AC load and an AC electrical source; wherein, optionally, control of the inverter takes precedence over control of the DC/DC converters.

15) (canceled)

16) (canceled)

17) (canceled)

18) A method for managing power in an electrical power distribution network, the method including in one or more electronic processing devices:
a) determining one or more parameters of a system, the system including:
i) a plurality of DC/DC converters each electrically coupled between the output of a respective DC source and a DC bus, the converters electrically coupled to the DC bus in parallel and each converter configured to transfer power from the DC source to the DC bus;
ii) at least one DC energy storage apparatus electrically coupled to the DC bus; and,
iii) at least one DC/AC inverter having an input electrically coupled to the DC bus and an output electrically coupled to at least one of an AC load and an AC electrical source;
and,
b) selectively controlling the DC/DC converters in accordance with the determined parameters to thereby selectively control transfer of power to the at least one energy storage apparatus.

19) A method according to claim 11, wherein at least one of:
a) an output of each DC/DC converter is independently controlled in accordance with the determined parameters including at least one of a converter output voltage and a DC bus voltage;
b) the at least one electronic processing device causes the inverter output to become synchronised with the AC source;
c) the control signal is generated at least in part by a machine learning algorithm or from historical data of the one or more operating parameters of the AC source.

20) A method according to claim 11, wherein the method includes, in the one or more electronic processing devices, at least one of:
a) transmitting a common voltage limit to each DC/DC converter;
b) implementing a Maximum Power Point Tracking (MPPT) algorithm in each DC/DC converter until the output of the DC/DC converter reaches the common voltage limit; and
c) regulating the output once the voltage limit is reached so that the voltage limit is not exceeded;
d) controlling the inverter to selectively cause power to flow between the DC bus and at least one of the AC load and an AC electrical source.

21) (canceled)

22) (canceled)

23) A method according to claim 13 wherein control of the inverter takes precedence over control of the DC/DC converters.

24) A method according to claim 11, the method including, in one or more electronic processing devices:
a) determining parameter values of one or more operating parameters of the AC source;
b) determining target parameter values of the one or more operating parameters;
c) determining a difference between the parameter values and target parameter values; and,
d) generating a control signal based at least in part on the determined difference to control the inverter and thereby selectively cause power flow between the DC bus and the AC source, the power flow causing the parameter values to tend towards the target parameter values.

25) A method according to claim 15, wherein the one or more operating parameters of the AC source include at least one of:
a) AC source frequency;
b) AC source voltage;
c) Phase loading; and
d) Load power factor.

26) A method according to claim 16, wherein the AC source includes at least one of a utility grid or a generator.

27) A method according to claim 15, wherein at least one of:
a) the step of determining the parameter values includes, in the at least one electronic processing device:
i) determining measured values of an AC voltage magnitude, AC current magnitude and AC current phase angle at the inverter output; and
ii) determining measured values of an AC voltage magnitude, AC current magnitude and AC current phase angle at the AC source;
b) the control signal causes the inverter to at least one of:
i) cause power flow from the AC source to the DC bus; and,
ii) cause power flow from the DC bus to the AC source;
c) the control signal causes the inverter to cause power flow from the DC bus to the at least one AC load;
d) at least the one or more electronic processing devices, the inverter, the energy storage apparatus, the at least one AC load, the AC source and one or more external communication networks are controlled through wireless communication.

28) (canceled)

29) (canceled)

30) A method according to claim 18, wherein the power flow includes at least one of real power (kW) and reactive power (kVAR); wherein, optionally, the method includes, in the at least one electronic processing device, generating a control signal which causes the inverter to actuate one or more switching devices to control operation of the at least one AC load.

31) (canceled)

32) (canceled)

33) (canceled)

34) (canceled)

35) A method according to claim 15, the method including, in one or more electronic processing devices, generating a plurality of control signals based at least in part on the determined difference to control a plurality of inverters and thereby selectively cause power flow between a plurality of energy storage apparatus and the AC source, the power flow causing the parameter values to tend towards the target parameter values.
